(19) United States
(12) Patent Application Publication
(10) Pub. No.: US 2006/0076339 A1
(43) Pub. Date: Apr. 13, 2006

(54) Furniture heating pad

(76) Inventors: Michael E. Mohn, Monroe, MI (US); Mark D. McClung, Grandview, TN (US); Larry P. LaPointe, Temperance, MI (US)

Correspondence Address: HARNESS, DICKEY & PIERCE, P.L.C., P.O. BOX 828, BLOOMFIELD HILLS, MI, 48303, US

(21) Appl. No.: 10/963,405

(22) Filed: Oct. 12, 2004

(51) Int. Cl. H05B 1/00; H05B 3/00; H05B 11/00

(52) U.S. Cl. 219/217

(57) ABSTRACT

A piece of furniture utilizes a movable heating member or heating pad that can be positioned at various locations on the furniture and/or on a user of the furniture. The heating pad is selectively operable to generate heat. The heating pad can be selectively connected to and unconnected from the piece of furniture for use and storage in a convenient storage location on the furniture.

### FIELD OF THE INVENTION

The present invention relates to furniture and, more particularly, to furniture having a heating pad.

### BACKGROUND OF THE INVENTION

Furniture used to provide a seating or resting surface for a person(s) is typically configured to provide a comfortable experience. In an effort to improve the comfort of a user of the piece of furniture, it is known to provide internal heating members that can be selectively operated to heat various portions of the furniture. The selective operation of the heating members allows a user to heat portions of their body when positioned on the furniture. The use of heat can provide a therapeutic experience that is both soothing and relaxing. At other times, the user may wish to not be warmed by the furniture. Thus, it is advantageous to provide selectively operable heaters in furniture that enables a user to turn the heaters on and off to provide a desired level of comfort.

The use of internal fixed heating members within the furniture, however, limits the portions of a user's body that can be heated by the heating members. Specifically, only the portions of the user that are positioned on or adjacent the heating members will receive the therapeutic effect of the heating members. In an effort to increase the portions of a user's body that can be heated, it is advantageous to include multiple fixed heaters that are spaced throughout the various portions of the furniture. The positioning of such heaters throughout the piece of furniture, however, can increase the complexity and cost associated with the furniture item. Furthermore, the heating members are still only operable to heat the portions of the user's body that can be positioned on or adjacent to the heating members. Thus, it would be further advantageous to provide a heating member that can be moved to various locations on the furniture and/or positioned on the user to heat the desired portion of the user. Furthermore, it would be advantageous if such a heating member could be easily connected and disconnected from the furniture and stored when not in use. It would be further advantageous if such a heating member had an upholstery that matches the upholstery of the furniture to provide a desired aesthetic appearance. Moreover, it would be advantageous to provide pockets or pouches in the movable heating member that enable various body parts, such as hands, feet and arms, to be placed therein and heated.

### SUMMARY OF THE INVENTION

A piece of furniture according to the principles of the present invention utilizes a movable heating member or heating pad that can be positioned at various locations on the furniture and/or on a user of the furniture. The heating pad is selectively operable to generate heat. The heating pad can be selectively connected to and unconnected from the piece of furniture for use and storage in a convenient storage location on the furniture.

A furniture piece according to the principles of the present invention includes an exterior surface having a seating surface and a back supporting surface. A first heating member is disposed on at least one of the seating and back supporting surfaces and is fixed in place relative to an associated one of the seating and back supporting surfaces. The first heating member is selectively operable to generate heat. A second heating member may also be provided which is also operable to selectively generate heat. The second heating member is movable and capable of being placed upon the exterior surface of the furniture piece at various locations.

In another aspect of the present invention, the piece of furniture has an interior and an exterior surface including a seating surface and a back supporting surface. An internal power supply is disposed in the interior and is operable to be connected to an external power source. The internal power supply is operable to supply power to other components of the furniture piece. There is at least one connector plug extending from the power supply. A movable heating member is selectively connectable to the connector plug and is operable to selectively receive power from the power supply and generate heat. The movable heating member is capable of being disposed on the exterior surface at various locations while connected to the connector plug.

In yet another aspect of the present invention, the piece of furniture includes an exterior surface having at least one seating surface and at least one back supporting surface. The furniture piece also has an interior and a heating member which is operable to selectively generate heat. There is a pocket adjacent the heating member that allows a body part of a user of the furniture piece to be inserted therein and heated by the heating member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a perspective view of a piece of furniture having internal fixed heating members and a movable external heating member according to the principles of the present invention;

FIGS. 1B and 1C are close-up views respectively showing the hidden connector plug and external access to the hidden connector plug in the furniture piece of FIG. 1A which is used to connect the movable heating member to the furniture piece;

FIGS. 2A-2C are perspective views of the furniture piece of FIG. 1A with the movable heating member positioned on various locations of the exterior of the furniture piece;

FIG. 3 is a perspective view of a piece of furniture having a seating surface configured to support at least two users and having two movable heating members according to the principles of the present invention;

FIGS. 4A and 4B are respective schematic representations of the fixed and movable heating members used in the furniture piece of FIG. 1A;

FIG. 4C is a perspective view of the movable heating member used with the furniture piece of FIG. 1A;

FIG. 5 is a schematic representation of the heating system utilized in the furniture piece of FIG. 1A;

FIGS. 6A and 6B are simplified exploded views of the internal construction of the furniture piece of FIG. 1A showing the respective lumbar and seating heating members;

FIG. 7A is a perspective view of an alternate embodiment of the piece of furniture of FIG. 1A; and

FIGS. 7B and 7C are enlarged cross-sectional views of the respective arm rest and foot rest heating members in the piece of furniture of FIG. 7A.

### DETAILED DESCRIPTION OF THE PREFERRED EMBODIMENT

The following description of the preferred embodiment is merely exemplary in nature and is in no way intended to limit the invention, its application, or uses.

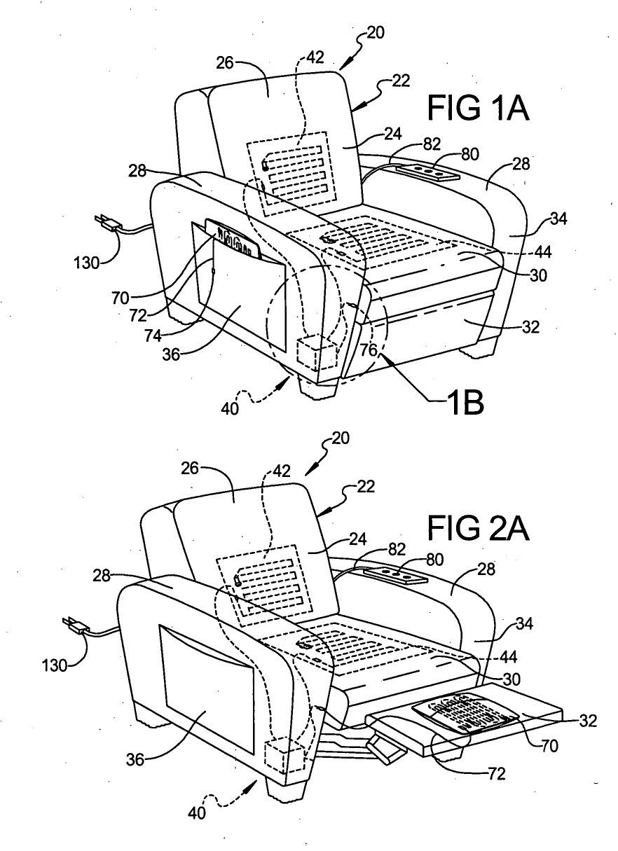

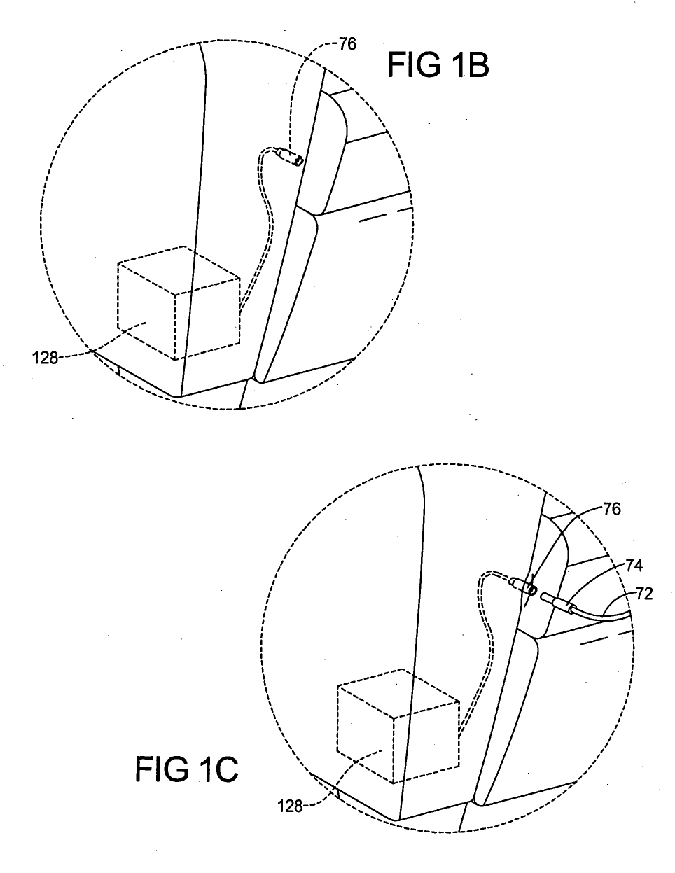

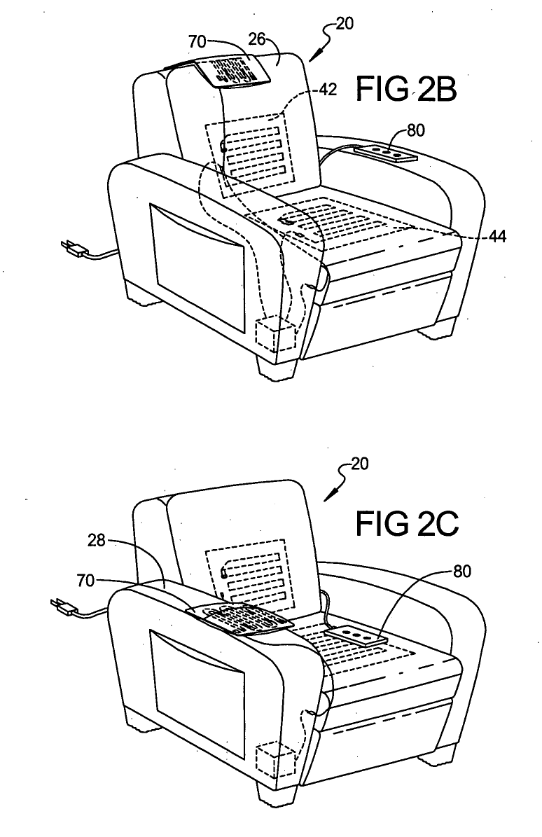

Referring to FIG. 1A, a furniture piece 20, in this case in the form of a chair, according to the principles of the present invention, is shown. Chair 20 has an exterior surface 22 that includes a back supporting surface 24, a head supporting surface 26, arm supporting surfaces or rests 28, a seating surface 30 and a leg supporting surface 32. Leg supporting surface 32 may be fixed in place or can be movable, such as when furniture piece 20 is a reclining chair, as shown in FIG. 2A, wherein leg supporting surface 32 is elevated and arranged in a generally horizontal orientation. Exterior surface 22 is covered by upholstery 34 that provides a desired appearance or pattern for furniture piece 20. Furniture piece 20 has a pocket 36 on exterior surface 22. Pocket 36 is configured to receive and hold the movable heating member of furniture piece 20 therein, as described in more detail below.

Furniture piece 20 has a heating system 40 therein that is operable to selectively heat various portions of furniture piece 20 and that of a user situated in furniture piece 20. Heating system 40 includes a first fixed heating member 42 that is positioned in back supporting surface 24. Preferably, first heating member 42 is in the lumbar region of back supporting surface 24. A second fixed heating member 44 is located in seating surface 30. First and second heating members 42, 44 are fixed within their respective surfaces 24, 26, such that heating members 42, 44 are stationary relative to the associated surfaces and move with the associated surfaces, such as when furniture piece 20 has reclining or tilting features.

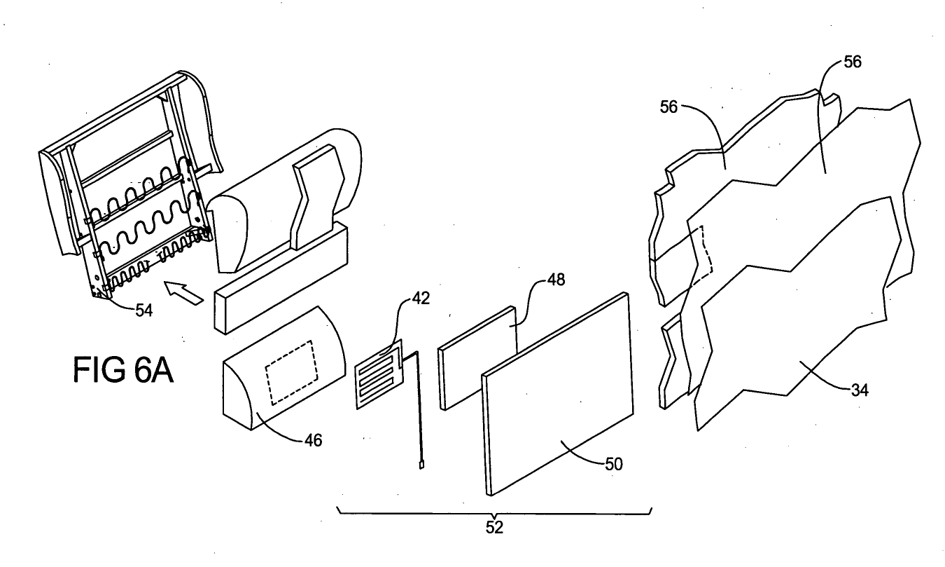

Referring to FIG. 6A, first heating member 42 is disposed between a polyurethane lower back cushion 46 and two sheets of polyester batting 48, 50. First heating member 42 is glued to lower back cushion 46 and batting sheet 48 is glued to first heating member 42 and lower back cushion 46. Second batting layer 50 is wrapped around and glued to the back, bottom and sides of lower back cushion 46 to form a first heating member assembly 52. Assembly 52 is secured to a back support frame 54 and covered by additional batting layers 56 and upholstery 34.

Referring now to FIG. 6B, second heating member 44 is disposed between a polyurethane foam slab 58 and a polyester batting layer 60 to form a second heating member assembly 62. Second heating member 44 is glued to slab 58 and batting 60 is glued to slab 56 sandwiching second heating member 44 therebetween. Second heating member assembly 62 is disposed above a polyurethane foam cushion 64 that is supported by a seat support frame 66 and is covered by an additional batting layer(s) and upholstery (not shown).

Referring to FIG. 1A, heating system 40 also includes a movable heating member or heating pad 70 having a cable 72 with a connector 74 thereon. Connector 74 is operable to connect to a hidden connector plug 76 on furniture piece 20, as described in more detail below. Movable heating member 70 can be positioned at a variety of locations on furniture piece 20 and/or on a user of furniture piece 20 to provide heat at that location. For example, as shown in FIG. 2A, movable heating member 70 can be positioned on leg supporting surface 32. Alternatively, movable heating member 70 can be positioned on head supporting surface 26, as shown in FIG. 2B. Furthermore, movable heating member 70 can be positioned on one of the arm supporting surfaces 28, as shown in FIG. 2C. Thus, movable heating member 70 is operable to be positioned at a variety of locations on furniture piece 20 as desired by a user of furniture piece 20.

Heating system 40 also includes a manual controller or control wand 80. Control wand 80 allows a user to selectively and independently activate first heating member 42, second heating member 44, and movable heating member 70. Activation of heating members 42, 44, 70 causes the associated heating member to generate heat, as described in more detail below. Control wand 80 is attached to heating system 40 with a cable 82 that allows control wand 80 to be moved and easily handled by a user of furniture piece 20.

Referring now to FIG. 1B, hidden connector plug 76 is shown. In its nominal state, connector plug 76 is hidden from view behind a portion of the seat cushion. Connector plug 76, however, is easily accessible from the exterior of furniture piece 20 by pushing a portion of the seat cushion aside thereby revealing connector plug 76, as shown in FIG. 1C. With the seat cushion pushed aside, connector 74 on movable heating member 70 can be easily connected to connector plug 76 to allow control wand 80 to control operation of movable heating member 70. When movable heating member 70 is not being used, it can be disconnected from connector plug 76 and stowed in pocket 36, as shown in FIG. 1A. Pocket 36 thereby provides a convenient storage place for movable heating member 70 when not being used.

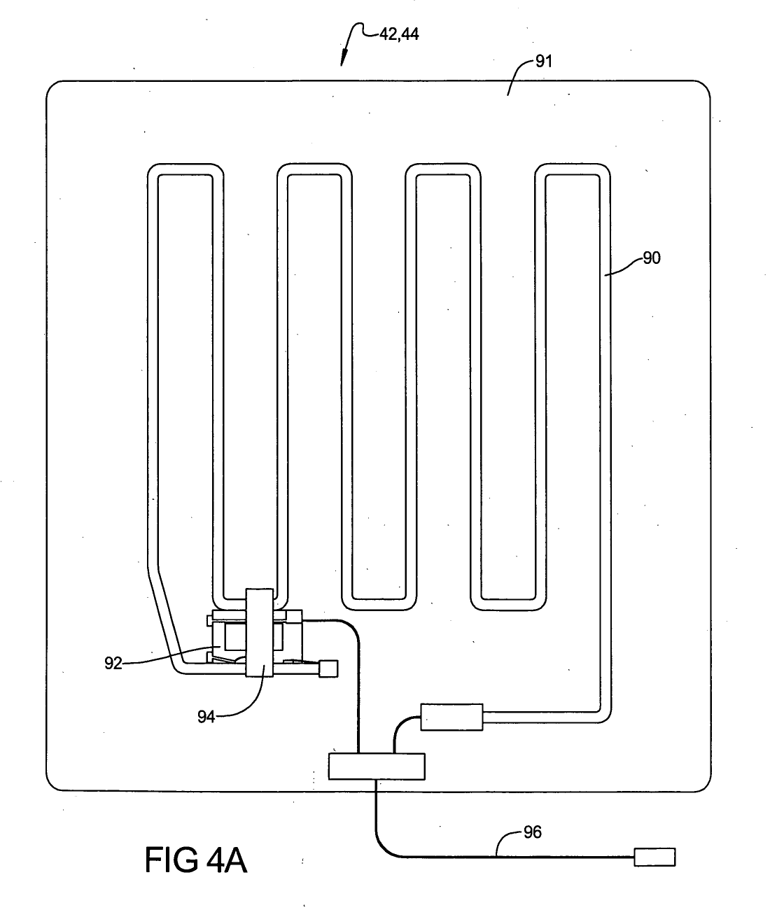

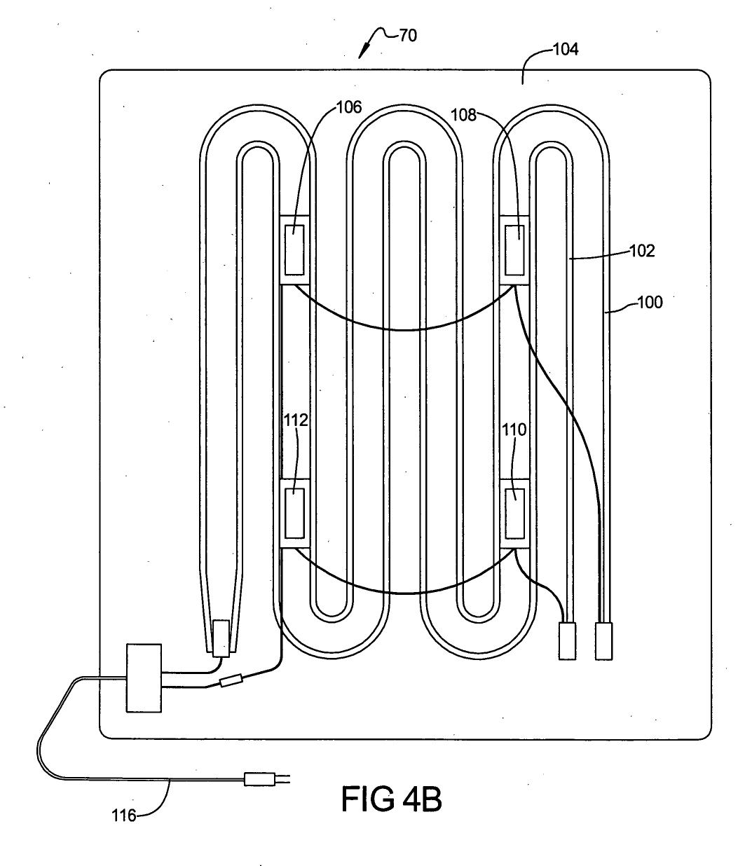

Referring now to FIG. 4A, a simplified schematic representation of first and second heating members 42, 44 are shown. Heating members 42, 44 are substantially similar in construction. Heating members 42, 44 each have a non-metallic conductive element 90 disposed between sheets of material 91. Specifically, conductive element 90 is disposed between two sheets of a polyester needle-punch material which in turn are disposed between two sheets of a non-woven material. A thermostat 92 is connected to conductive element 90 and controls the temperature of the heating member. Thermostat 92 is a fixed temperature thermostat that will stop current flow through conductive element 90 when the predetermined fixed temperature is reached. When the temperature drops below the predetermined fixed temperature, thermostat 92 will again allow current to flow through conductive element 90. A thermal cutoff 94 is also connected to conductive element 90. Thermal cutoff 94 is a fusable link that upon reaching a predetermined fixed temperature will sever and permanently prevent any current from flowing through conductive element 90. Thermal cutoff 94 is preferably established to sever at a fixed temperature substantially higher than that of thermostat 92 thereby avoiding inadvertent severing of thermal cutoff 94 due to temperature fluctuations caused by operation of thermostat 92. For example, thermostat 92 can have a fixed temperature setting of 65° C. while thermal cutoff 94 may have a fixed temperature setting of 115° C. Thus, thermal cutoff 94 would only be activated if thermostat 92 fails to cease current flow through conductive element 90 when the temperature exceeds its fixed temperature setting. Additionally, in the event thermal cutoff 94 fails to sever, the conductive element 90, being non-metallic, can melt thereby severing current flow therethrough and limiting the maximum temperature of the heating member 42, 44. Thus, heating members 42, 44 each have three redundant features that control the maximum temperature that can be achieved.

A cable 96 communicates with both ends of conductive element 90. Cable 96 is connected to the power supply of heating system 40 and enables current to flow to and from conductive element 90, as described in more detail below.

Referring now to FIG. 4B, a simplified schematic representation of movable heating member 70 is shown. Movable heating member 70 is preferably larger than first and second heating members 42, 44 and covers a larger area. Due to the increased size, movable heating member 70 includes a pair of conductive elements 100, 102 that are disposed between sheets of material 104. Specifically, conductive elements 100, 102 are disposed between two sheets of polyester needle-punch material which in turn are sandwiched between two sheets of polyester batting material. Four thermostats 106, 108, 110, 112 are associated with conductive elements 100, 102. A first pair of the thermostats 106, 108 are associated with conductive element 100 while the other pair of thermostats 110, 112 are associated with conductive element 102. Each thermostat 106, 108, 110, 112 has a fixed temperature that causes the thermostat to cycle the operation of the associated conductive element 100, 102 on and off based on the predetermined fixed temperature. Thermostats 106, 110 both have the same fixed temperature setting while thermostats 108, 112 each have the same fixed temperature setting that is higher than the fixed temperature setting of thermostats 106, 110. For example, thermostats 106, 110 may have a temperature setting of 65° C. while thermostats 108, 112 may have a temperature setting of 72° C. With this arrangement, thermostats 106, 110 (having a lower fixed temperature setting) serve as the main thermostats for movable heating member 70 and cycle off and on as the temperature of the associated conductive element 100, 102 exceeds and falls below the fixed temperature. The other thermostats 108, 112 function as a redundant control in the event that one of the primary thermostats 106, 110 fails. In the event of a failure of either thermostat 106, 110 to stop current flow, the associated secondary thermostat 108, 112 will then cause the associated conductive element 100, 102 to cycle off and on as the temperature of the associated conductive element 100, 102 exceeds and falls below the predetermined fixed temperature of the secondary thermostat 108, 112. There is no thermal cutoff in movable heating member 70 due to the existence of the redundant secondary thermostats. Additionally, with conductive elements 100, 102 being non-metallic, in the event of a failure of secondary thermostats 108, 112, conductive elements 100 and 102 upon reaching a predetermined temperature, will melt thereby ceasing their operation and preventing further current flow therethrough. Thus, movable heating member 70 has at least three redundant features that control the maximum temperature that can be achieved by movable heating member 70.

A cable 116 communicates with conductive elements 100, 102 and thermostats 106, 108, 110, 112. Cable 116 also communicates with the power supply of heating system 40 and is operable to supply and return current to and from conductive elements 100, 102, as described in more detail below.

Referring now to FIG. 4C, movable heating member 70 is shown. Movable heating member 70 is disposed within a cover 120. Preferably, cover 120 is made from the same material as upholstery 34 to match with the exterior surface of furniture piece 20. Alternatively, cover 120 can be different from upholstery 34, if desired. Cover 120 surrounds movable heating member 70 and has a pocket 122 therein. Pocket 122 is configured to allow a portion of a body of a user of furniture piece 20 to be inserted therein. For example, pocket 122 can receive one or more feet, hand(s), or arm(s) of a user to warm that body part therein. Cable 72 extends out from cover 120 to enable movable heating member 70 to be connected to connector plug 76. Because movable heating member 70 is flexible, movable heating member 70 can be draped over arm supporting surfaces 28 or head supporting surfaces 26 to provide warmth to a body part positioned thereon.

Each heating member 42, 44, 70 operates on 12-volt AC power and generates heat when a current is flowing therethrough. Heating members 42, 44, 70 are sized to provide a desired heating area and temperature profile to achieve a desired warming effect. The size and temperature profile of the heating members 42, 44, 70 can vary or be the same. First and second heating members 42, 44 preferably have the same size and temperature profile. Preferably, first and second heating members 42, 44 have a heating area of about 0.3 ft² and a power density of about 36 w/ft². Preferably, movable heating member 70 has a heating area of about 0.8 ft² and a power density of about 26 w/ft². Suitable heating members 42, 44, 70 can be acquired from Thermosoft International Corporation of Buffalo Grove, Ill.

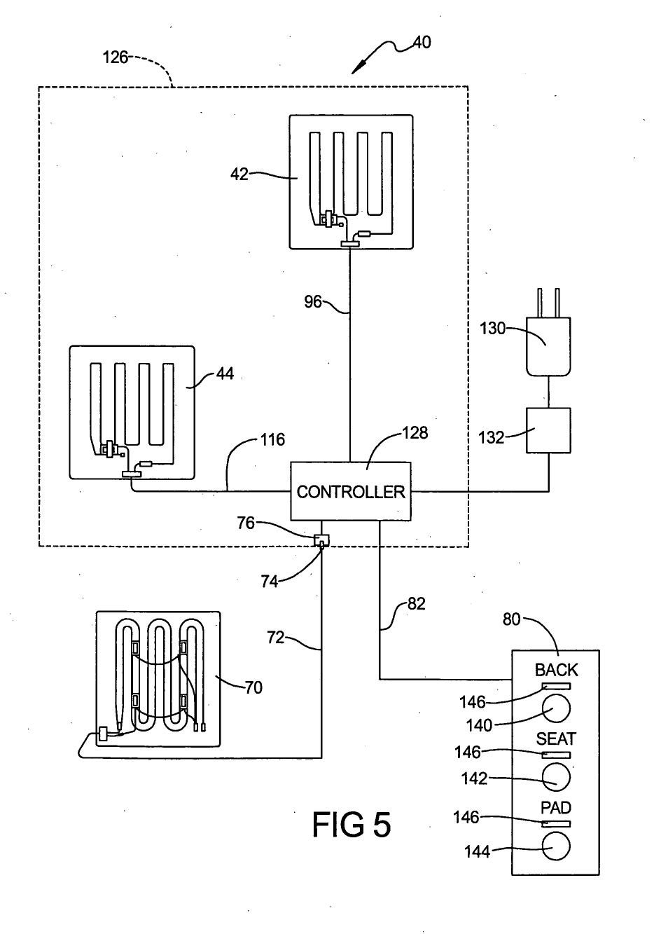

Referring now to FIG. 5, a schematic representation of heating system 40 is shown. Broken line 126 represents the boundary of furniture piece 20 and indicates which components of heating system 40 are internal and external of furniture piece 20. Heating system 40 includes a controller 128 that is operable to control and coordinate the operation of the various components of heating system 40. Controller 128 serves as an internal power supply and selectively supplies power from an external transformer (discussed below) to heating members 42, 44, 70. A plug 130 plugs into an external power source, such as a standard 120-volt AC socket (not shown). Plug 130 extends from a transformer 132 which is connected to controller 128. Transformer 132 is operable to convert 120-volt AC to 12-volt AC. The 12-volt AC power is sent to controller 128. Transformer 132 and plug 130 are external to furniture piece 20.

Controller 128 communicates with heating members 42, 44, 70 and is operable to selectively provide 12-volt AC power to each of them. Controller 128 can provide full or half power to each heating member 42, 44, 70 as commanded by control wand 80. For example, controller 128 can provide every AC cycle for full power or every other AC cycle for half power to heating members 42, 44, 70 to respectively provide full power heating or one-half power heating.

Control wand 80 communicates with controller 128 and commands controller 128 to selectively provide power to heating members 42, 44, 70. Control wand 80 includes three pushbuttons 140, 142, 144 that are respectively associated with controlling heat generation in heating members 42, 44, 70. Each button 140, 142, 144 can be manually depressed by a user of furniture piece 20. There is also an LED 146 associated with each pushbutton 140, 142, 144. LEDs 146 can display two different colors or be off to indicate the power levels of the associated heating members 42, 44, 70.

When pushbuttons 140, 142, 144 are pushed once, controller 128 sends one-half power to the associated heating member 42, 44, 70 and the associated LED's 146 illuminate in a first color. When one of the same pushbuttons is depressed a second time, controller 128 supplies full power to the associated heating member and the associated LED changes to a second color indicative of the high power level. When that same pushbutton is depressed a third time, controller 128 terminates power supply to the associated heating member and the associated LED turns off indicating that the associated heating member is no longer being operated.

Continuous operation of each heating member 42, 44, 70 is limited to a predetermined timing cycle. Controller 128 contains a timing circuit for each heating member 42, 44, 70 that allows the associated heating member to be active for the duration of the timing cycle. At the completion of the timing cycle, controller 128 terminates the power flow to the associated heating member. Each timing cycle is set to a predetermined duration and is not capable of being changed by the user. For example, each timing cycle may be set to 30 minutes so that each heating member can be activated for a continuous 30-minute period of time after which it is automatically shut off. A suitable controller 128 can be procured from In-Seat Solutions of Costa Mesa, Calif.

Thus, a furniture piece 20 according to the principles of the present invention is operable to selectively heat fixed portions of furniture piece 20 while also having a movable heating member 70 operable to selectively heat various portions of a user of furniture piece 20. The heating members can each be independently operated at two different power levels and have redundant features to prevent overheating. Furthermore, each heating member can be turned on for a predetermined cycle time at the conclusion of which the associated heating member is deactivated.

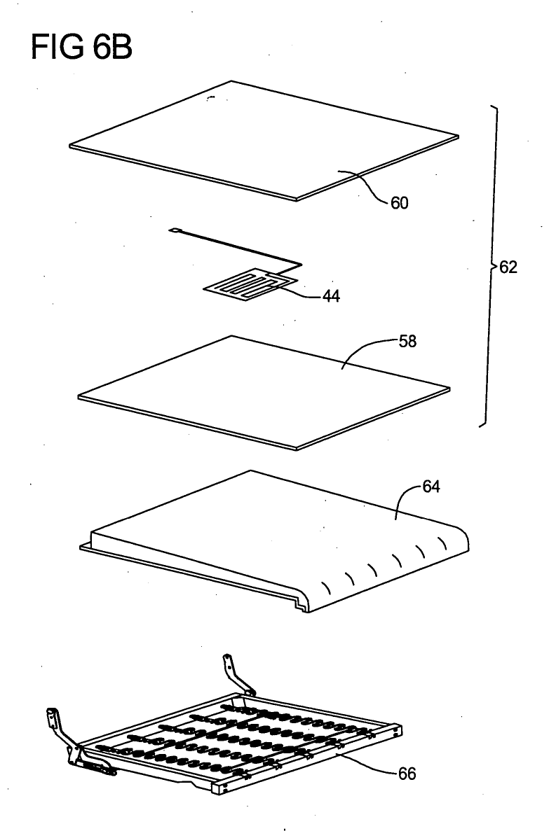

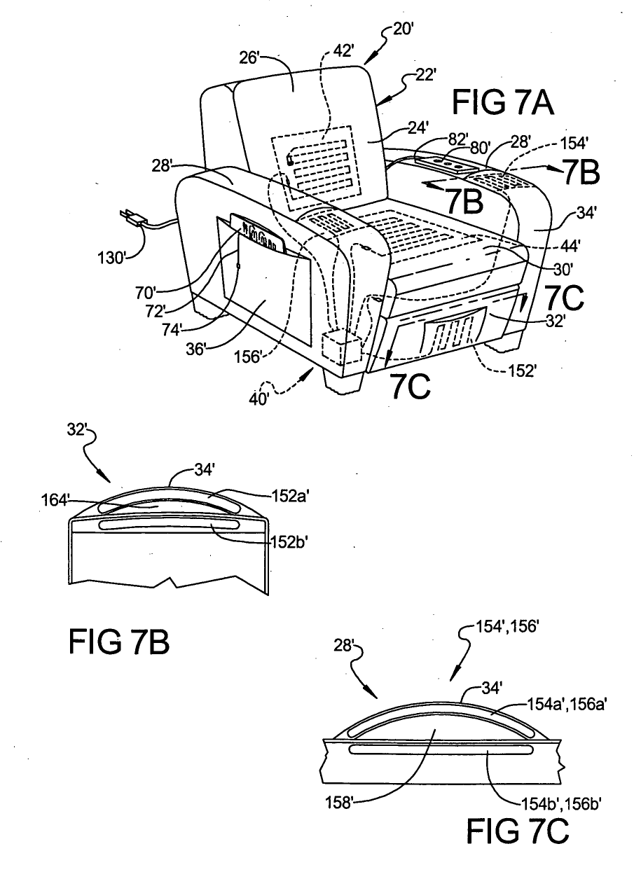

Referring now to FIG. 7A, an alternate embodiment of furniture piece 20′ is shown. Furniture piece 20′ is substantially the same as furniture piece 20 shown in FIG. 1A with the addition of more heating members disposed in surfaces of furniture piece 20′. Heating system 40′ includes a third fixed heating member 152′ that is positioned in leg supporting surface 32′. Fourth and fifth fixed heating members 154′, 156′ are located in each arm supporting surface 28′. Heating members 152′, 154′, 156′ are fixed within their respective surfaces 32′, 28′.

Referring now to FIG. 7B, details of fourth and fifth heating members 154′, 156′ are shown. Each heating member 154′, 156′ includes an upper portion 154a′, 156a′ and a lower portion 154b′, 156b′ that are spaced apart to form a pocket 158′ therebetween. Each portion 154a′, 156a′, 154b′, 156b′ has one or more layers of polyester batting disposed on both sides thereof. Heating members 154′, 156′ are also enclosed within upholstery 34′. The opening that leads to pocket 158′ enables a hand of a user of furniture piece 20′ to be inserted therein for warming. Thus, when a hand is placed within pocket 158′, the hand will be warmed from heating members both above and below the hand. Alternatively, a user can place their hand on top of arm supporting surface 28′ and be heated from one side only.

Referring now to FIG. 7C, details of third heating member 152′ are shown. Third heating member 152′ also includes upper and lower heating portions 152a′, 152b′ that are disposed within layers of polyester batting and upholstery 34′. Third heating member 152′ has a pocket 164′ between upper and lower heating members 152a′, 152b′ that enables the feet of a user of furniture piece 20′ to be inserted therein. Upper and lower heating member portions 152a′, 152b′ enable the feet therein to be heated on both sides. Alternatively, a user can rest their feet on leg supporting surface 32′ and be heated on only one side.

The entrance to each pocket 158′, 164′ can be made to be secured in a closed position when not in use. For example, a hook-and-loop fastener, such as Velcro®), can be disposed on the material layers forming the pockets so that the pockets can be selectively opened and closed to allow access thereto.

Heating members 152′, 154′, 156′ are substantially similar in construction to first and second heating members 42, 44 and include a non-metallic conductive element disposed between polyester needle punch material and/or non-woven material which is then positioned between the batting layers. The operation of heating members 152′, 154′, 156′ is substantially the same as that discussed above with reference to first and second heating members 42, 44 and, accordingly, will not be discussed further. It should be appreciated that heating members 152′, 154′, 156′ are sized to provide a desired heating area and temperature profile to achieve a desired warming effect which may be the same as or different than that of first and second heating members 42′, 44′. Additionally, heating members 152′, 154′, 156′ will also be controlled by control wand 80′ and controller 128′. Moreover, furniture piece 20′ can also include a movable heating member 70′, as shown in FIG. 7A, if desired.

Thus, in the alternate embodiment of furniture piece 20′, three additional heating members 152′, 154′, 156′ are added to furniture piece 20′. Additionally, heating members 152′, 154′, 156′ each have pockets therein that allow a part of a user's body to be inserted therein to be heated on both sides. Alternatively, heating members 152′, 154′, 156′ can have only an upper or lower portion to provide heating on only one surface of a body part inserted into the associated pocket.

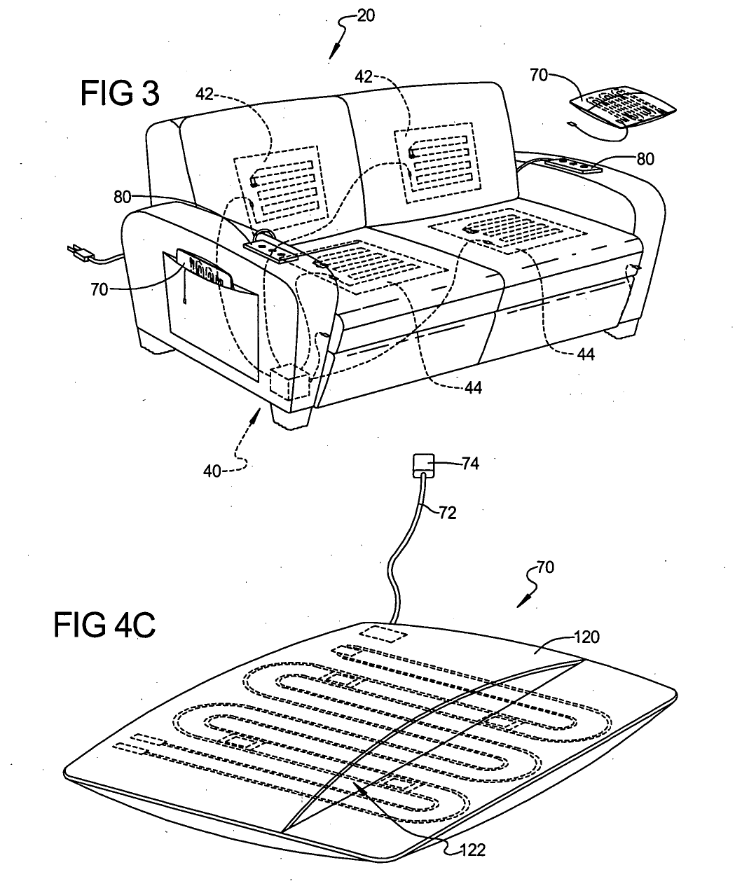

While the present invention has been described and shown with reference to specific heating capabilities and locations, it should be appreciated the description of the invention is merely exemplary in nature and variations can be made without departing from the spirit and scope of the present invention. For example, the heating members can be sized to provide differing power densities and/or different operating temperatures. Furthermore, the heating members can operate on a power source other than 12-volt AC. Additionally, more or less than two power settings can be provided for each heating member. Moreover, the present invention can be utilized on furniture pieces other than those shown. For example, the present invention can be used on a sofa, a lift chair, a massage chair and the like. Furthermore, each piece of furniture can include more than one movable heating member, such as shown in FIG. 3. There can also be more than one hidden connector plug for the movable heating member thereby allowing for a shorter cable 72. Additionally, connector plug 76 can be on a retractable cord that would allow connector plug 76 to be pulled in and out from the furniture piece, thereby allowing for a shorter cable 72. Alternatively, cable 72 could be on a retractable mechanism to allow the length of cable 72 to be increased and decreased, as desired. Transformer 132 can also be operable to supply additional power, such as 24-volt DC, to the furniture piece 20 to operate other features such as electric motors for lifting, reclining and massaging. Such variations are not to be regarded as a departure from the spirit and scope of the invention.

1. A furniture piece comprising:
an exterior surface with at least two resting areas, each resting area including:
a seating surface and a back supporting surface;
a first heating member disposed in at least one of said seating and back supporting surfaces, said first heating member being fixed in place relative to an associated one of said seating and back supporting surfaces and selectively operable to generate heat;
a second heating member operable to selectively generate heat, said second heating member being external to said exterior surface, moveable and capable of being placed upon said exterior surface at various locations;
an internal controller operable to selectively supply power from an external power source to said first and second heating members; and
a moveable manual controller for each resting area, said controllers communicating with said internal controller and operable to allow a user to control operation of said first and second heating members in an associated resting area independently of each other.

2. (canceled)

3. The furniture piece of claim 2, further comprising at least one connector plug operable to supply power to said second heating member from said controller and wherein said second heating member has a cable operable to selectively connect to said connector plug to receive power from said controller.

4. The furniture piece of claim 3, wherein said at least one connector plug is hidden from view and externally accessible.

5. (canceled)

6. The furniture piece of claim 1, further comprising a third heating member disposed in the other of said seating and back supporting surfaces, said third heating member being fixed in place relative to an associated one of said seating and back supporting surfaces and selectively operable to generate heat.

7. The furniture piece of claim 1, wherein said exterior surface includes an arm supporting surface, a head supporting surface and a foot supporting surface and said second heating member is selectively disposable on said arm, head and foot supporting surfaces.

8. The furniture piece of claim 1, wherein said exterior surface includes a pocket operable to store said second heating member.

9. The furniture piece of claim 1, wherein said second heating member includes a pocket operable to receive a body part of a user of the furniture piece and heat a body part therein.

10. A furniture piece comprising:
an exterior surface including a seating surface and a back supporting surface;
an internal controller operable to be connected to an external power source and to supply power to other components of the furniture piece;
at least one connector plug extending from said internal controller, said plug being hidden from view when not in use and externally accessible; and
a moveable heating member selectively connectable to said connector plug and operable to selectively receive power from said internal controller and generate heat, said moveable heating member capable of being disposed on said exterior surface at various locations while connected to said connector plug.

11. The furniture piece of claim 10, wherein said exterior surface includes upholstery and said moveable hearing member is covered in upholstery that is substantially the same as said exterior surface upholstery.

12. The furniture piece of claim 10, wherein said seating surface is sized to accommodate at least two users.

13. The furniture piece of claim 10, further comprising at least one fixed heating member operable to selectively receive power from said internal controller and generate heat, said fixed heating member disposed in one of said seating and back supporting surfaces and fixed relative to an associated one of said seating and back supporting surfaces.

14. The furniture piece of claim 10, wherein said exterior surface includes a pouch operable to receive said moveable heating member.

15. (canceled)

16. The furniture piece of claim 10, further comprising a transformer operable to convert AC voltage from an external source of power to 12-volt AC and said moveable heating member uses said 12-volt AC power to generate heat.

17. A furniture piece comprising:
an exterior surface including at least one seating surface and at least one back supporting surface;
a heating member operable to selectively generate heat; and
a pocket adjacent said heating member, said pocket allowing a body part of a user of the furniture piece to be inserted therein and heated by said heating member.

18. The furniture piece of claim 17, wherein said heating member is a moveable heating member that can be positioned on various portions of said exterior surface, said heating member is disposed within a cover, and said pocket is formed by a portion of said cover.

19. The furniture piece of claim 18, further comprising an internal controller operable to selectively supply power from an external power source to said heating member.

20. The furniture piece of claim 19, wherein said heating member is a moveable heating member and further comprising at least one fixed heating member disposed in at least one of said seating and back supporting surfaces, said fixed heating member selectively operable to generate heat, and said fixed heating member being fixed in position relative to an associated one of said seating and back supporting surfaces.

21. A furniture piece comprising:
an exterior surface including an arm supporting surface and a leg supporting surface;
a heating member disposed on at least one of said arm and leg supporting surfaces, said heating member being substantially fixed in place relative to an associated one of said arm and leg supporting surfaces and selectively operable to generate heat; and
a cover enclosing a portion of said heating member, said cover including a cavity configured to receive a body part of a user of the furniture piece to selectively heat a body part therein.

22. The furniture piece of claim 21, wherein said heating member includes upper and lower heating portions and said cavity is disposed between said upper and lower heating portions.

23. The furniture piece of claim 21, wherein said arm supporting surface is one of a pair of arm supporting surfaces, said heating member is a first heating member and further comprising a second heating member selectively operable to generate heat and at least partially enclosed by a cover having a cavity configured to receive a body part of a user of the furniture piece to selectively heat a body part therein,
wherein each heating member is located on one of said arm supporting surfaces.

24. The furniture piece of claim 23, further comprising a third heating member selectively operable to generate heat and at least partially enclosed by a cover having a cavity configured to receive a body part of a user of the furniture piece to selectively heat a body part therein, said third heating member being located on said foot supporting surface.

25. The furniture piece of claim 21, further comprising an internal controller operable to be connected to an external power source and to said supply power to said heating member.

26. The furniture piece of claim 1, wherein each controller is operable to control all aspects of operation of the heating of the furniture piece for the associated seating area.

27. The furniture piece of claim 10, wherein said plug is hidden from view by a cushion on said furniture piece.

28. A furniture piece comprising;
an exterior surface with at least one resting area, said at least one resting area including:
a seating surface and a back supporting surface;
a first heating member disposed in at least one of said seating and back supporting surfaces, said first heating member being fixed in place relative to an associated one of said seating and back supporting surfaces and selectively operable to generate heat;
a second heating member operable to selectively generate heat said second heating member being external to said exterior surface, moveable and capable of being placed upon said exterior surface at various locations;
an internal controller operable to selectively supply power from an external power source to said first and second heating members; and
a moveable manual controller for said at least one resting area, said controller communicating with said internal controller and operable to allow a user to control operation of said first and second heating members in an associated resting area.

29. The furniture piece of claim 28, further comprising a timing circuit that limits continuous operation of at least one of said heating members to a predetermined timing cycle.
